(19) United States
(12) Patent Application Publication
(10) Pub. No.: US 2009/0152452 A1
(43) Pub. Date: Jun. 18, 2009

(54) REFLECTIVE MULTI-TURN ENCODER

(75) Inventors: Sze Kuang Lee, Penang (MY); Weng Fei Wong, Penang (MY)

Correspondence Address: Kathy Manke;Avago Technologies Limited, 4380 Ziegler Road, Fort Collins, CO, 80525, US

(73) Assignee: AVAGO TECHNOLOGIES ECBU IP (SINGAPORE) PTE. LTD., Singapore (SG)

(21) Appl. No.: 11/959,193

(22) Filed: Dec. 18, 2007

(51) Int. Cl. G01D 5/34

(52) U.S. Cl. 250/231.15; 250/231.14

(57) ABSTRACT

A reflective optical encoder for a gear train. The reflective optical encoder includes a gear train with a plurality of gears. Each of the gears is operably coupled to at least one other gear of the plurality of gears. A reflective code pattern is accessible on a surface of at least one of the gears. A reflective optical sensor detects light reflected by the reflective code pattern. Position logic coupled to the optical sensor determines a rotational parameter of the gear train based on the light reflected by the reflective code pattern. Additionally, the position logic may determine rotational parameter of a pinion coupled to the gear train based on the rotational parameter of the gear train.

### BACKGROUND OF THE INVENTION

Optical encoders are used to monitor the motion of, for example, a gear or a shaft such as a crank shaft. Optical encoders can monitor the motion of a gear in terms of position and/or number of revolutions of the gear. Optical encoders are employed in systems to provide high resolution within tight size limitations.

An optical encoder may be used to monitor rotational motion of a gear. For monitoring gear movement, conventional multi-turn optical encoders typically employ magnetic or transmissive encoding technology. Conventional implementations of magnetic encoders are limited because of prevalent interference by external magnetic fields.

Transmissive optical encoders typically use a code wheel integrated into the body of a gear to modulate light as the gear rotates. In a transmissive code wheel, the light is modulated as it passes through transmissive sections of a track on the code wheel. The transmissive sections are separated by non-transmissive sections. As the light is modulated in response to the rotation of the code wheel, a stream of electrical signals is generated from a photosensor array, which receives the modulated light. The electrical signals are used to determine the position and/or number of revolutions of the gear.

Transmissive multi-turn encoders are implemented in conjunction with gears that have holes in the center, or body, in order for light to pass through and be detected by a transmissive optical detector. However, the hole openings prevent the gears (e.g., in a gear train) from being packed very closely together because the gears are located so that light passing through one gear is not obstructed by another gear. The use of transmissive hole openings also limits the precision for injection molded gears. In addition, at least two substrates—one on each side of the gear or gear train—are used to mount the light source on one side of the gear and the light detector on the other side of the gear.

### SUMMARY OF THE INVENTION

Embodiments of a system are described. In one embodiment, the system is a reflective optical encoder for a gear train. An embodiment of the reflective optical encoder includes a gear train with a plurality of gears. Each of the gears is operably coupled to at least one other gear of the plurality of gears. A reflective code pattern is accessible on a surface of at least one of the gears. A reflective optical sensor detects light reflected by the reflective code pattern. Position logic coupled to the optical sensor determines a rotational parameter of the gear train based on the light reflected by the reflective code pattern. Additionally, the position logic may determine rotational parameter of a pinion coupled to the gear train based on the rotational parameter of the gear train.

Another embodiment of the reflective optical encoder gear includes a gear with a reflective code pattern accessible on a surface of the gear. A reflective optical sensor detects light reflected by the reflective code pattern. Position logic coupled to the reflective optical sensor determines a rotational parameter of the gear train based on the light reflected by the reflective code pattern. Other embodiments of the reflective optical encoder are also described.

Embodiments of an apparatus are also described. In one embodiment, the apparatus is an apparatus to monitor rotational movement of a pinion coupled to a gear train. An embodiment of the apparatus includes means for generating light incident on a surface of a gear within a gear train, means for detecting a rotational movement of the gear within the gear train, and means for computing a rotational movement of a pinion coupled to the gear train based on the rotational movement of the gear within the gear train. Another embodiment of the apparatus also includes means for reflecting a modulated light signal from the surface of the gear within the gear train. Other embodiments of the apparatus are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic circuit diagram of one embodiment of a reflective optical encoding system.

FIG. 2 depicts a stylized diagram of one embodiment of a reflective absolute code wheel.

FIGS. 3A, 3B, and 3C depict schematic diagrams of alternative embodiments of a reflective code wheel.

FIG. 4 depicts a schematic diagram of one embodiment of a sensor layout for a reflective code wheel.

FIGS. 5A and 5B depict a schematic diagram of one embodiment of a gear train multi-turn encoder.

FIG. 6 depicts a schematic diagram of one embodiment of the gear train of FIGS. 5A and 5B with a code pattern accessible on an outside surface of the second layer of gears.

FIG. 7 depicts a schematic diagram of another embodiment of the gear train of FIGS. 5A and 5B with a code pattern accessible on an inside surface of the second layer of gears.

FIGS. 8A and 8B depict schematic diagrams of another embodiment of the gear train of FIGS. 5A and 5B with code patterns accessible on the outside and inside surfaces of the second layer of gears.

FIG. 9 depicts a schematic diagram of another embodiment of the gear train of FIGS. 5A and 5B with code patterns, which are accessible from a single side of the gear train, on all of the gears within the gear train.

FIGS. 10A through 10G depict schematic diagrams of various embodiments of the gear train of FIGS. 5A and 5B with one or more locations for code patterns accessible on one or more gears of the gear train.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments relate to a multi-turn encoder which implements a reflective optical technology. In particular, a reflective sensor can be placed on a single side or both sides of a gear (or gear train) to monitor a rotational movement of the gear (or gear train). Using a reflective optical sensing technology, in contrast to a transmissive optical sensing technology, allows smaller form factors and more flexibility in gear placement. Other embodiments are also described below with specific reference to the corresponding figures.

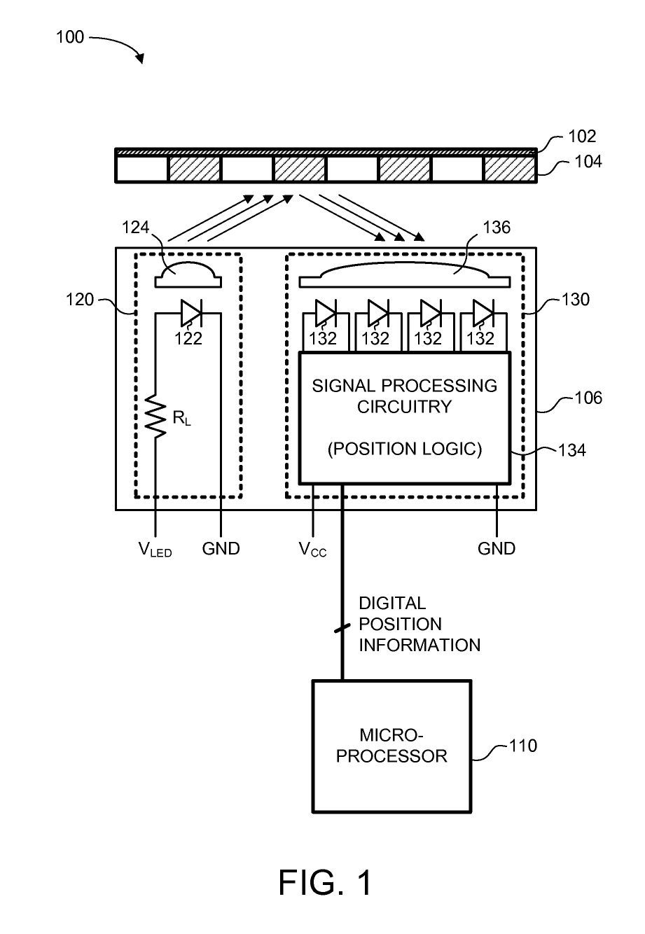

FIG. 1 depicts a schematic circuit diagram of one embodiment of a reflective optical encoding system 100. The illustrated reflective optical encoding system 100 includes a reflective material 102, a code wheel 104, an encoder 106, and a microprocessor 110. In one embodiment, the reflective material 102 is a coating or a substrate that is physically coupled to the code wheel 104. In some embodiments, the reflective surface of the reflective material 102 is coupled to the code wheel 104 opposite the encoder 106.

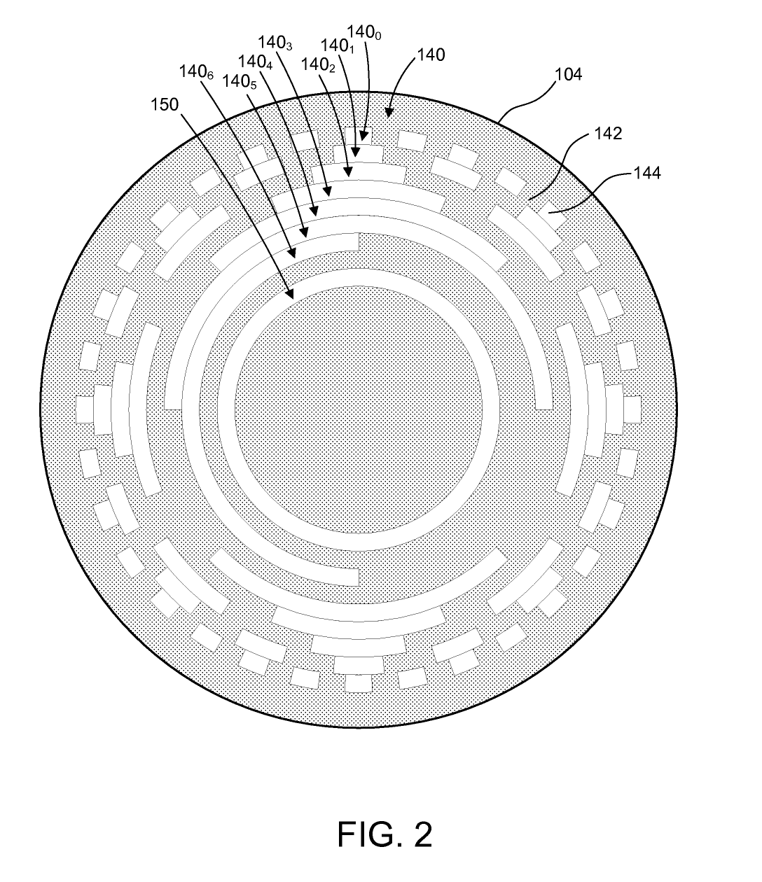

Although a more detailed, exemplary illustration of the code wheel 104 is provided in FIG. 2, a brief explanation is provided here as context for the operation of the reflective optical encoding system 100 shown in FIG. 1. In general, the code wheel 104 includes one or more tracks 140 of reflective sections 142 and non-reflective sections 144. An emitter 120 in the encoder 106 produces light that is incident on the code wheel tracks 140. As the code wheel 104 is rotated, for example by a gear or motor shaft (not shown), the incident light is reflected by the reflective sections 142 of the tracks 140, but is not reflected by the non-reflective sections 144 of the tracks 140. Thus, the light is reflected by the tracks 140 in a modulated pattern (i.e., on-off-on-off . . . ). A detector 130 in the encoder 106 detects the modulated, reflected light signal and, in response, generates one or more corresponding signals. In some embodiments, the detector 130 also may generate a monitor signal or an indexing signal. These signals are then transmitted to the microprocessor 110. The microprocessor 110 uses the signals to evaluate the movement of, for example, the gear or motor shaft or other moving part to which the code wheel 104 is coupled.

In one embodiment, the encoder 106 includes the emitter 120 and the detector 130. The emitter 120 includes a light source 122 such as a light-emitting diode (LED). For convenience, the light source 122 is described herein as an LED, although other light sources, or multiple light sources, may be implemented. In one embodiment, the LED 122 is driven by a driver signal, V_{LED}, through a current-limiting resistor, R_{L}. The details of such driver circuits are well-known. Some embodiments of the emitter 120 also may include a lens 124 aligned with the LED 122 to direct the projected light in a particular path or pattern. For example, the lens 124 may focus the light onto one or more of the code wheel tracks 140.

In one embodiment, the detector 130 includes one or more photosensors 132 such as photodiodes. The photosensors may be implemented, for example, in an integrated circuit (IC). For convenience, the photosensors 132 are described herein as photodiodes, although other types of photosensors may be implemented. In one embodiment, the photodiodes 132 are uniquely configured to detect a specific pattern or wavelength of reflected light. In some embodiments, several photodiodes 132 may be used to detect modulated, reflected light signals from multiple tracks 140. Also, the photodiodes 132 may be arranged in a pattern that corresponds to the radius and design of the code wheel 104. The various patterns of photodiodes 132 are referred to herein as photosensor arrays. The signals produced by the photodiodes 132 are processed by signal processing circuitry 134 which generates the digital position information. In one embodiment, the signal processing circuitry includes position logic to generate the digital position information according to the detected light from the multiple tracks 140.

In one embodiment, the detector 130 also includes one or more comparators (not shown) to generate the digital position information. For example, analog signals from the photodiodes 132 may be converted by the comparators to transistor-transistor logic (TTL) compatible, digital output signals. In one embodiment, these output signals indicate position and direction information for the modulated, reflected light signal. Additionally, the detector 130 may include a lens 136 to direct the reflected light signal toward the photodiodes 132.

In some embodiments, the emitter 120 and one or more photodiodes 132 may be positioned together in a group, and a single lens 136 may be used for the emitter 120 and the photodiodes 132. Additionally, some embodiments may implement several groups of emitters 120 and photodiodes 132, with or without corresponding lenses 136.

In one embodiment, the reflective optical encoding system 100 includes components for determining absolute position. For example, the encoder 106 may include additional photodiodes 132, LEDs 122, or other components to allow the encoder 106 to determine an absolute angular position of the code wheel 104 upon power up. The absolute angular position can be determined using many known techniques. One exemplary technique, with corresponding hardware, is described in more detail in U.S. patent Ser. No. 11/445,661, filed on Jun. 2, 2006, entitled “Multi-bit absolute position optical encoder with reduced number of tracks,” which is incorporated by reference herein. Another exemplary absolute encoder is described in more detail in U.S. Pat. No. 7,112,781, entitled “Absolute encoder,” which is incorporated by reference herein. Additional details of emitters, detectors, and optical encoders, generally, may be referenced in U.S. Pat. Nos. 4,451,731, 4,691,101, and 5,241,172, which are incorporated by reference herein.

FIG. 2 depicts a stylized diagram of one embodiment of a reflective absolute code wheel 104. In particular, FIG. 2 illustrates a top view of a circular absolute code wheel 104 in the shape of a disc. In some embodiments, the code wheel 104 may be in the shape of a ring, rather than a disc. The illustrated code wheel 104 includes multiple tracks 140, which may be circular tracks that are concentric with the code wheel 104. For example, the depicted code wheel 104 includes seven different tracks designated as track 140₀ (the outermost track), track 140₁, track 140₂, track 140₃, track 140₄, track 140₅, track 140₆ (the innermost track).

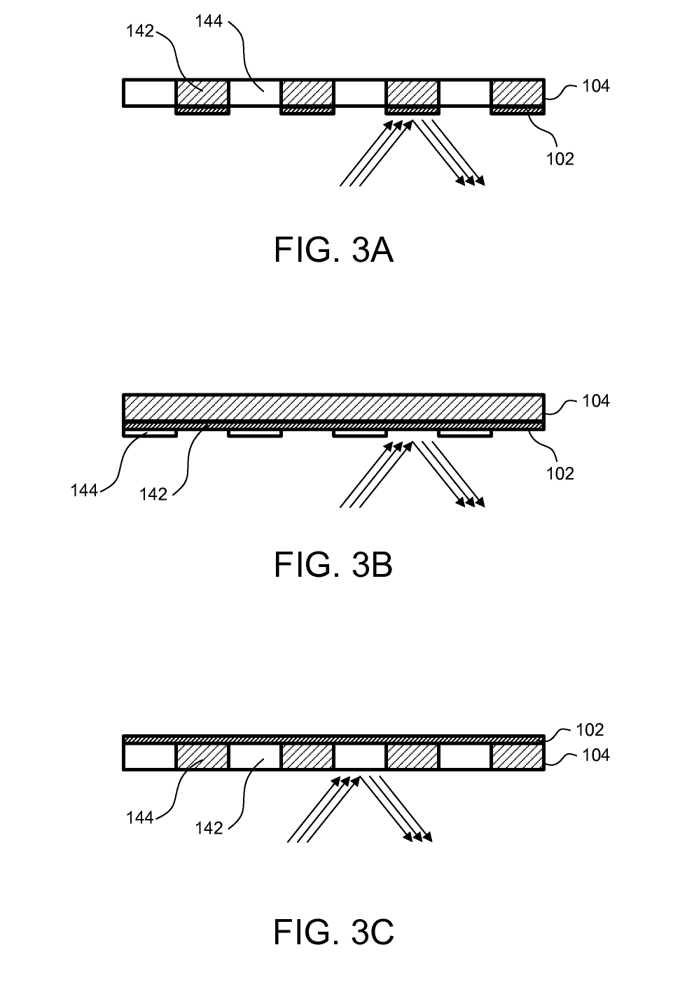

In one embodiment, each track 140 includes a continuous repeating pattern that goes all the way around the code wheel 104. The depicted pattern of each track 140 includes alternating reflective sections 142 and non-reflective sections 144, although other patterns may be implemented. These reflective sections 142 and non-reflective sections 144 are also referred to as position sections. In one embodiment, the reflective sections 142 of the code wheel 104 are reflective spokes of the code wheel 104, and the non-reflective sections 144 are transparent windows or voids (without a reflective coating 102 on the opposite side of the windows or voids). In this embodiment, the entire code wheel 104 may have a reflective material 102 applied to the near surface. This embodiment is illustrated in FIG. 3A.

In another embodiment, the underside of the code wheel 104 may be coated with reflective material 102 such as bright nickel (Ni) or chrome, and a non-reflective track pattern can be applied to the reflective material 102. The non-reflective pattern may be silk-screened, stamped, ink jet printed, or otherwise applied directly onto the reflective surface on the code wheel 104. Alternatively, the non-reflective pattern may be formed as a separate part such as by injection molding, die-cutting, punching (e.g., film), or otherwise forming a non-reflective component which has opaque spokes on it. This embodiment is illustrated in FIG. 3B.

In another embodiment, the reflective sections 142 are transparent sections of the code wheel 104 with a reflective coating 102 on the opposite side of the code wheel 104. In this embodiment, the non-reflective sections 144 may be opaque so that they absorb the light from the LED 122. This embodiment is illustrated in FIG. 3C.

Of the various embodiments described herein, some or all of the described embodiments may be implemented in conjunction with one or more gears, for example, in a gear train. Alternatively, it should be noted that, in some embodiments, the circular code wheel 104 could be replaced with a coding element that is not circular. For example, a linear coding element such as a code strip may be used in conjunction with a rack in an implementation having a rack and pinion. In another embodiment, a circular coding element may be implemented with a spiral bar pattern, as described in U.S. Pat. No. 5,017,776, which is incorporated by reference herein. Alternatively, other light modulation patterns may be implemented on various shapes of coding elements. Additionally, the reflective code pattern can be produced using a reflective plastic film, a metal code disk, a reflective coating on a plastic material, or any other type of manufacturing process.

As described above, rotation of the code wheel 104 and, hence, the track 140 results in modulation of the reflected light signal at the detector 130 to generate absolute positional signals corresponding to the angular position of the code wheel 104. For this reason, the tracks 140 may be referred to as position tracks. Other embodiments of the code wheel 104 may include other tracks such as additional position tracks, as are known in the art.

In one embodiment, each radial combination of position tracks 140 (e.g., taken along a radius of the code wheel 104) corresponds to a unique digital position output. For example, an exemplary radial combination of position tracks 140 corresponds to a digital position output of 1101010. In one embodiment, each bit of the digital position output corresponds to one of the position tracks 140. As one example, the code wheel 104 provides 12 bits of resolution. However, other embodiments may provide other bit resolutions. In some embodiments, the least significant bit (LSB) may correspond to the first position track 140₀, and the most significant bit (MSB) may correspond to the last position track 140₆. Alternatively, other bit ordering may be implemented. Also, a convention may be used to designate digital high and low signals, e.g., non-reflective sections 144 correspond to a digital low signal, “0,” and reflective sections 142 correspond to a digital high signal, “1.” Alternatively, other digital conventions may be used.

In the depicted embodiment, the position track sections 142 and 144 within each track 140 have the same circumferential dimensions (also referred to as the width dimension). In other words, the intermediate non-reflective track sections 144 in the first (outermost) position track 140₀ have the same width dimension as the reflective track sections 142 in the first position track 140₀. Similarly, the reflective and non-reflective track sections 142 and 144 in the second position track 140₁, have equal width dimensions (which, in this depicted embodiment are twice the width of the track sections 142 and 144 of the first position track in position track 140₀). The resolution of each position track 140 of the code wheel 104 is a function of the width dimensions of the positional track sections 142 and 144. In one embodiment, the width dimensions of the non-reflective track sections 144 are a function of the amount of area required to produce a detectable gap between consecutive, reflected light pulses. The position tracks 140 also have a radial, or height, dimension.

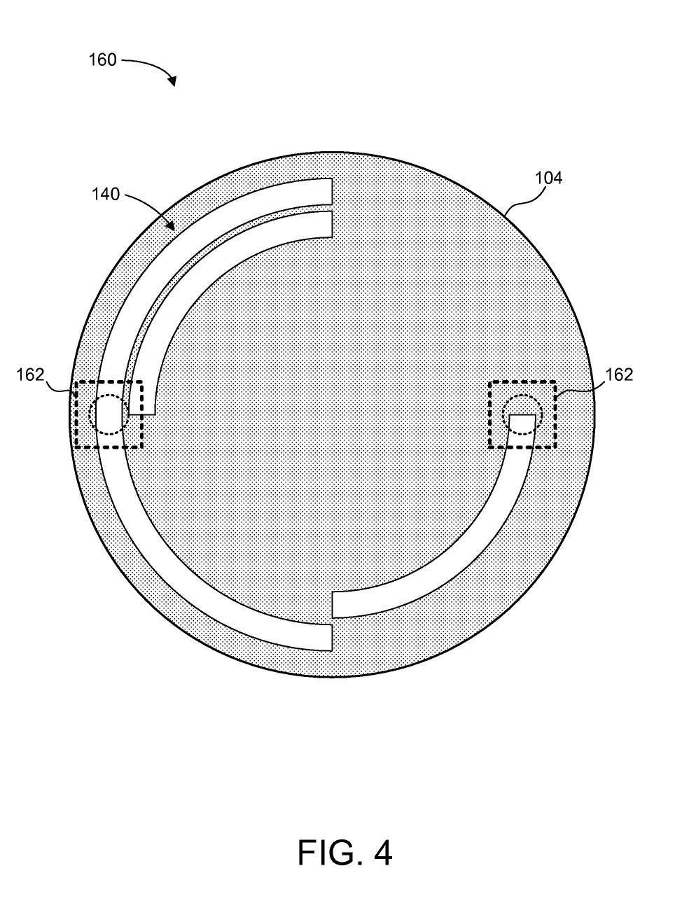

FIG. 4 depicts a schematic diagram of one embodiment of a sensor layout 160 for a reflective code wheel 104. In the illustrated embodiment, the only two position tracks 140 of the code wheel 104 are shown. For each position track 140, an optical sensor 162 is aligned with the corresponding position track 140 to detect light reflected from the corresponding position track 140. In the illustrated example, two optical sensors 162 are shown—one for each of the illustrated position tracks 140. Other embodiments may utilize more than one optical sensor 162 for each position track 140. In some embodiments, one sensor (e.g., with multiple photodiodes) may be used to detect light reflected from multiple position tracks 140. For example, a single detector 130 may include optical sensors 162 to detect two, four, or another number of position tracks 140.

In one embodiment, the optical sensors 162 are substantially similar to the detector 130 shown and described above with reference to FIG. 1. Although the optical sensors 162 are located at approximately diametrically opposed positions in FIG. 3, other embodiments may implement multiple optical sensors 162 that are co-located at approximately the same location relative to the code wheel 104. For example, some embodiments implement a photodetector array that is formed on a single substrate, with individual photodiodes 132 aligned with the corresponding position tracks 140 of the code wheel 104.

It should be noted that the geometrical dimensions of the photodiodes 132 corresponding to one or more optical detectors 162 may be referenced to the corresponding optical sizes of the track sections 142 and 144 of the track 140. For example, optical magnification may be used to optically match the sizes of the photodiodes 132 and the track sections 142 and 144. In one embodiment, the optical magnification is approximately 2× so that a geometrically smaller code wheel 104 is optically matched to a larger array of photodiodes 132. This optical magnification may be achieved, for example, by using one or more optical lenses.

Also, it should be noted that multiple photodiodes 132 may be used per track 140. In one embodiment, the signals from each set of photodiodes 132 for a single track 140 may be averaged together or otherwise combined to result in a single output signal for each of the corresponding sets of photodiodes 132.

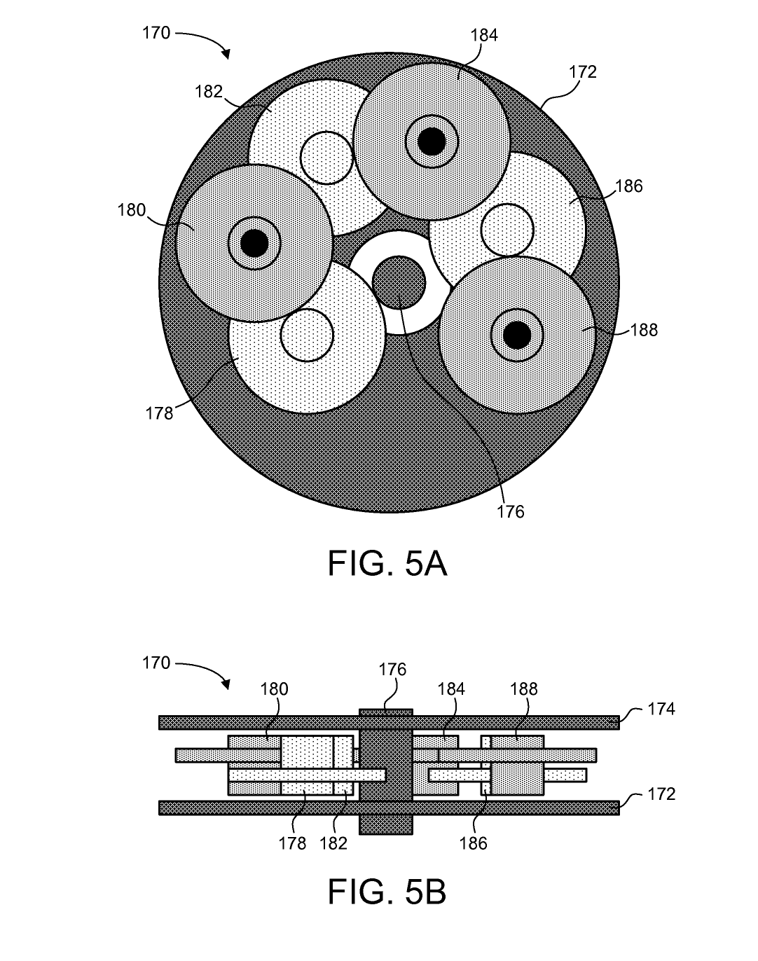

FIGS. 5A and 5B depict a schematic diagram of one embodiment of a gear train multi-turn encoder 170. The illustrated gear train multi-turn encoder 170 includes a first substrate 172 and a second substrate 174. The first and second substrates 172 and 174 are located on opposite sides of the gear train. Although some descriptions may refer to the first and second substrates 172 and 174 as top and bottom substrates, or vice versa, such references are merely for illustrative purposes and are not limiting to the actual orientation of the gear train multi-turn encoder 170.

The illustrated gear train multi-turn encoder 170 also includes a pinion 176 that projects through one or both of the first and second substrates 172 and 174. The pinion 176 is operably coupled to the gear train, which may include one or more gears. For simplicity, the gears of the gear train are shown in FIG. 5A using circular representations, without depicting the gear teeth. Hence, the gears are shown at approximately the pitch diameter of the gears. The illustrated gear train includes six gears 178, 180, 182, 184, 186, and 188. Other embodiments may include fewer or more gears.

The illustrated gears are subdivided into a first layer of gears (178, 182, and 186) and a second layer of gears (180, 184, and 188). As depicted in FIG. 5B, the first layer of gears is closer to the first substrate 172 (e.g., the bottom substrate), and the second layer of gears is closer to the second substrate 174 (e.g., the top substrate).

In general, reflective optical sensing technology is integrated with the gear train of the multi-train encoder 170 to facilitate sensing the movement of one or more gears in the gear train and, in turn, the rotation of the pinion 176. In one embodiment, a reflective code pattern is applied or otherwise integrated into the surface(s) of one or more gears within the gear train. Several exemplary embodiments are described below. One or more reflective optical sensors 162 are located, for example, on the first and/or second substrates 172 and 174, and the reflective optical sensors 162 are aligned with position tracks 140 of the reflective code pattern to detect light reflected from the corresponding position tracks 140. In one embodiment, the reflective optical sensors 162 are package devices. In some embodiments, the reflective optical sensors 162 are chip-on-board (COB) devices. Other embodiments may implement other types of reflective optical sensors 162. Based on the detected movement of one or more of the gears in the gear train, the movement of the pinion 176 can be calculated with some degree of accuracy.

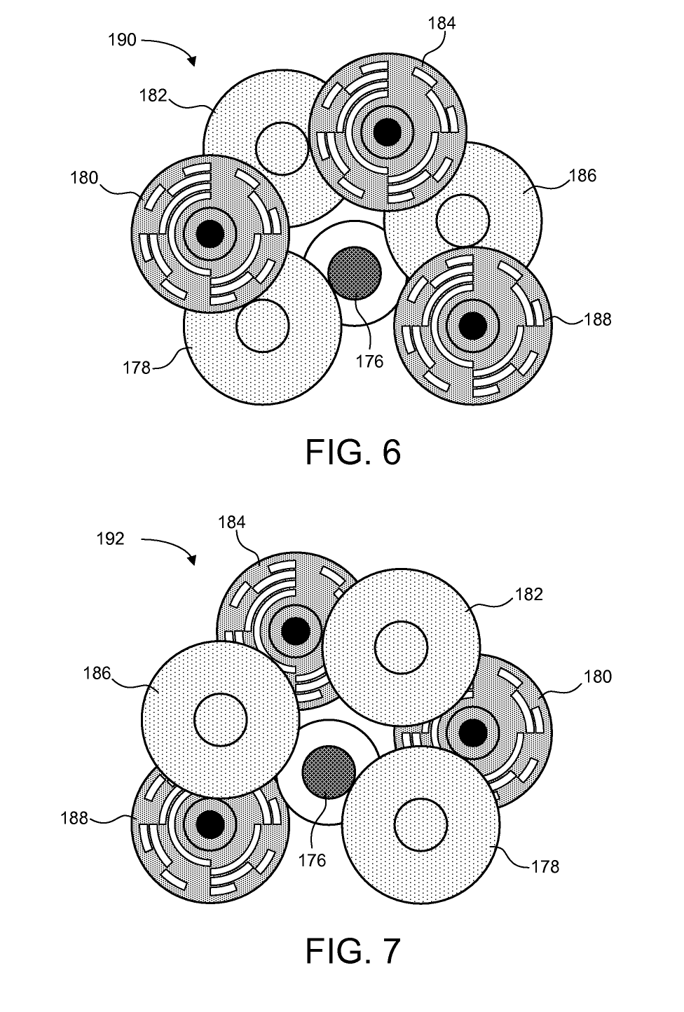

FIG. 6 depicts a schematic diagram of one embodiment of the gear train 190 of FIGS. 5A and 5B with a code pattern accessible on an outside surface of the second layer of gears. As explained above, the second layer of gears of the gear train 190 includes the alternating gears 180, 184, and 188. The same or different reflective code patterns are applied to each of the outside surfaces of the gears 180, 184, and 188. With exemplary reference to FIG. 5B, the outside surface of the gears 180, 184, and 188 corresponds to the top surfaces of the gears 180, 184, and 188 facing the top substrate 174. Hence, in one embodiment, a reflective optical sensor 162 may be located on the top substrate 174, facing the gear train 190, to detect the reflective code patterns on the outside surfaces of the second layer of gears. In some embodiments, where the reflective code patterns are applied to less than all of the gears, the number of tracks of each reflective code pattern may vary. As one example, the number of tracks of each reflective code pattern may be doubled in an embodiment in which the reflective code patterns are applied to half of the gears (e.g., every other gear). In this way, the number of tracks used for the reflective code patterns may be altered in order to accommodate a specific gear reduction ratio (e.g., 4 or another ratio). In other embodiments, different numbers of tracks may be used for different reflective code patterns within the same gear train.

FIG. 7 depicts a schematic diagram of another embodiment of the gear train 192 of FIGS. 5A and 5B with a code pattern accessible on an inside surface of the second layer of gears. In contrast to the embodiment of FIG. 6 described above, and with exemplary reference to FIG. 5B, the reflective code patterns are applied to the inside surface facing the first layer of gears, instead of the outside surface facing the top substrate 174. Hence, in one embodiment, a reflective optical sensor 162 may be located on the bottom substrate 172, facing the gear train 190, to detect the reflective code patterns on the inside surfaces of the second layer of gears. The reflective optical sensors 162 may be located and oriented on the bottom substrate 172 to provide an unobstructed light path for the incident and reflected light. For example, the reflective optical sensors 162 may be located between or otherwise away from the gears 178, 182, and 186 in the first layer of gears, so that the first layer of gears does not obstruct access to the reflective code patterns on the inside surface of the second layer of gears.

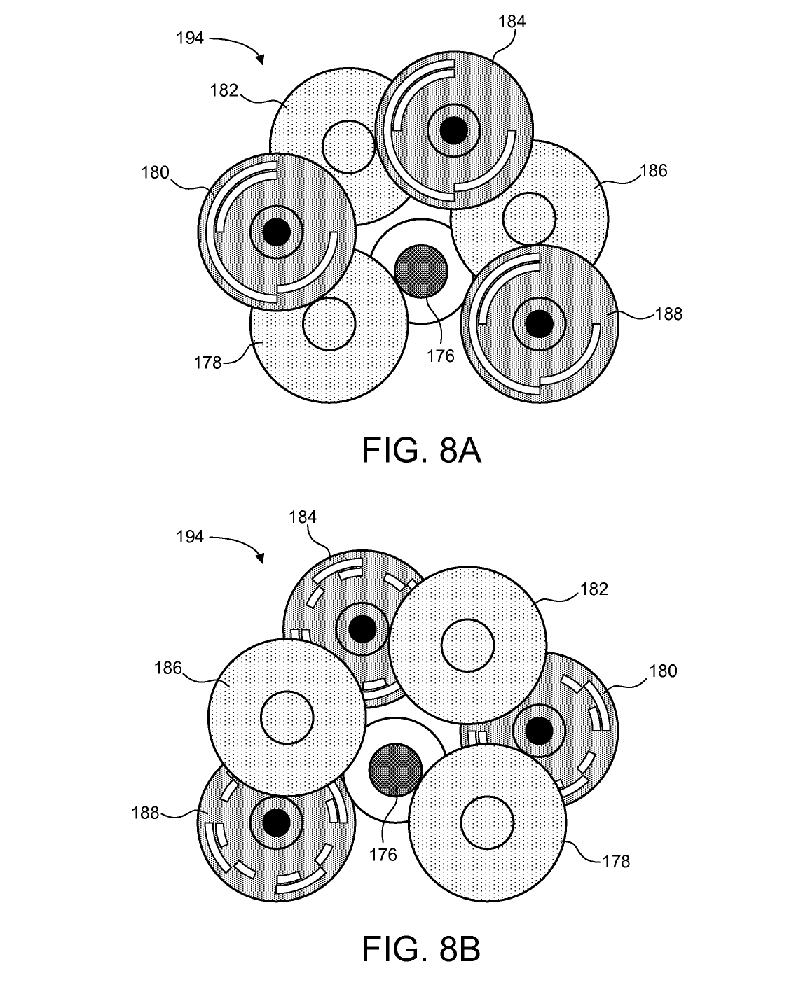

FIGS. 8A and 8B depict schematic diagrams of another embodiment of the gear train 194 of FIGS. 5A and 5B with code patterns accessible on the outside and inside surfaces of the second layer of gears. In other words, reflective code patterns may be applied to or integrated with both the top and bottom surfaces of the gears 180, 184, and 188 of the second layer of gears. Hence, with exemplary reference to FIG. 5B, reflective optical sensors 162 may be located on both the bottom and top substrates 172 and 174 to detect light reflected from the reflective code patterns on both the inside and outside surfaces, respectively, of the second layer of gears. In one embodiment, the reflective code patterns on the inside surface may be different from the reflective code patterns on the outside surface of the second layer of gears.

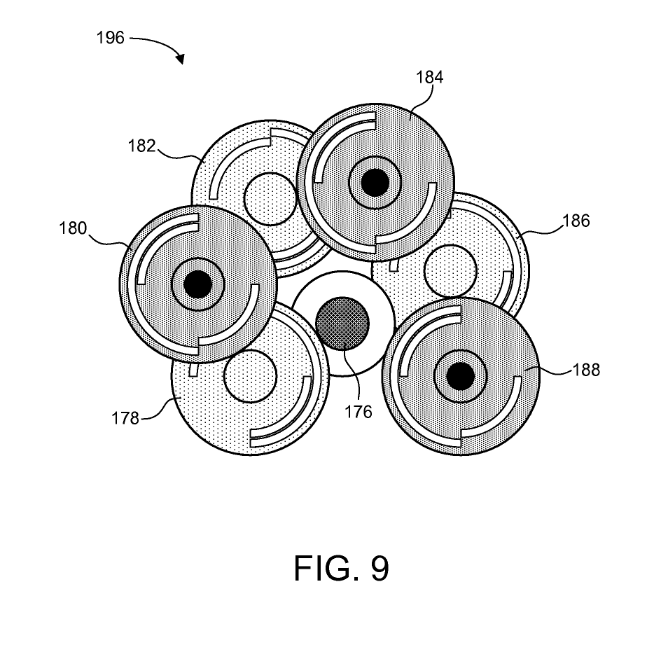

FIG. 9 depicts a schematic diagram of another embodiment of the gear train 196 of FIGS. 5A and 5B with code patterns, which are accessible from a single side of the gear train, on all of the gears within the gear train. Hence, with exemplary reference to FIG. 5B, reflective optical sensors 162 may be located on the top substrate 174 to detect light reflected from the reflective code patterns on the outside surface of the second layer of gears and, additionally, to detect light reflected from the reflective code patterns on the inside surface of the first layer of gears.

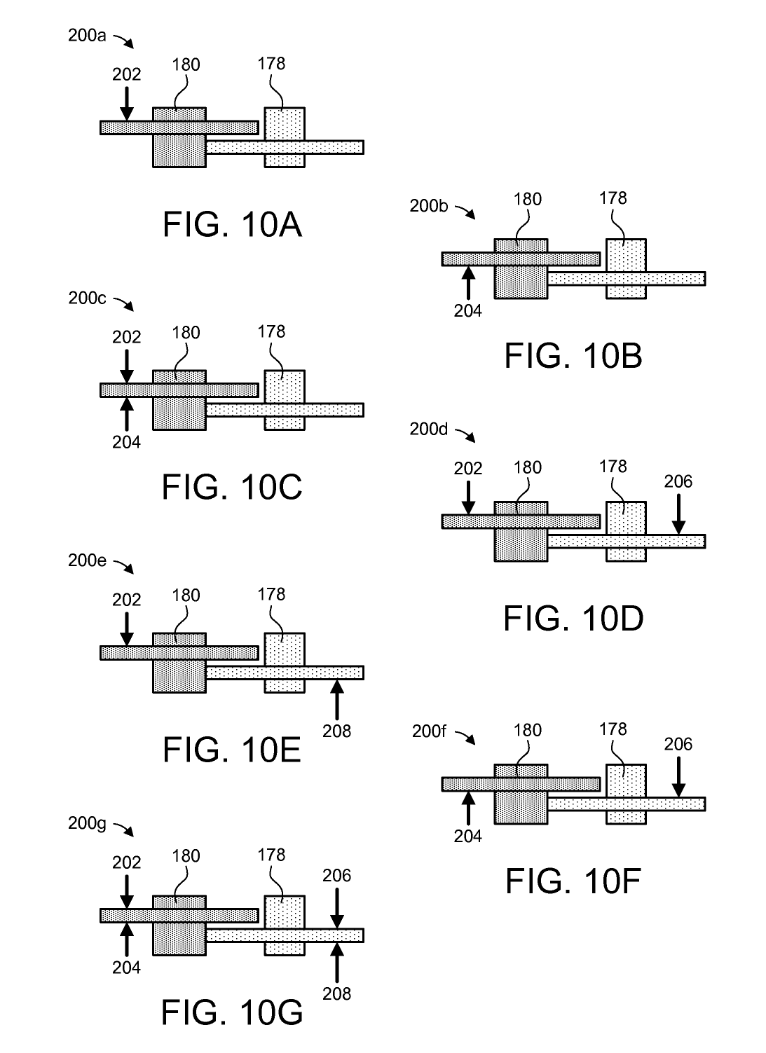

FIGS. 10A through 10G depict schematic diagrams of various embodiments of the gear train of FIGS. 5A and 5B with one or more locations for code patterns accessible on one or more gears of the gear train. For illustration purposes only, the arrows shown in FIGS. 10A through 10G indicate surfaces of the corresponding gears 178 and/or 180 to which reflective code patterns are applied. Reflective optical sensor(s) 162 may be provided at corresponding locations on the substrates 172 and/or 174.

In the layout 200a of FIG. 10A, the reflective code pattern is applied to the outside surface 202 of the gear 180, and a corresponding reflective optical sensor 162 may be located, for example, on the top substrate 174 of the multiturn encoder 170. This layout 200a corresponds to the embodiment shown in FIG. 6 and described above.

In the layout 200b of FIG. 10B, the reflective code pattern is applied to the inside surface 204 of the gear 180. Corresponding reflective optical sensor 162 may be located, for example, on the bottom substrate 172 of the multiturn encoder 170. This layout 200b corresponds to the embodiment shown in FIG. 7 and described above.

In the layout 200c of FIG. 10C, reflective code patterns are applied to both the outside surface 202 and the inside surface 204 of the gear 180. Corresponding reflective optical sensors 162 may be located, for example, on the top substrate 174 and the bottom substrate 172 of the multiturn encoder 170. This layout 200c corresponds to the embodiment shown in FIGS. 8A and 8B and described above.

In the layout 200d of FIG. 10D, reflective code patterns are applied to both the outside surface 202 of the gear 180 and the inside surface 206 of the gear 178. Corresponding reflective optical sensors 162 may be located, for example, on the top substrate 174 of the multiturn encoder 170. This layout 200d corresponds to the embodiment shown in FIG. 9 and described above.

In the layout 200e of FIG. 10E, reflective code patterns are applied to both the outside surface 202 of the gear 180 and the outside surface 208 of the gear 178. Corresponding reflective optical sensors 162 may be located, for example, on the top substrate 174 and the bottom substrate 172 of the multiturn encoder 170.

In the layout 200f of FIG. 10F, reflective code patterns are applied to both the inside surface 204 of the gear 180 and the inside surface 206 of the gear 178. Corresponding reflective optical sensors 162 may be located, for example, on the bottom substrate 172 and the top substrate 174 of the multiturn encoder 170.

In the layout 200g of FIG. 10G, reflective code patterns are applied to all of the surfaces of the gears 180 and 178. Corresponding reflective optical sensors 162 may be located, for example, on both the bottom substrate 172 and the top substrate 174 of the multiturn encoder 170. Other embodiments may use other surface combinations for the reflective code patterns.

Embodiments of the reflective optical encoding system 100 described above are suitable for small form factor encoders. This allows the reflective optical encoder system 100 to be used in applications with limited space. Additionally, embodiments of the reflective optical encoding system 100 facilitate flexibility for gear placement, as well as placing the reflective optical sensors 162 on one or both sides of the gear or gear train. Also, some embodiments of the reflective optical encoding system 100 can generate a direct raw signal of any format such as Gray code, binary code, or other codes which cannot be generated by embodiments of a transmissive multi-turn encoding system.

Although specific embodiments of the invention have been described and illustrated, the invention is not to be limited to the specific forms or arrangements of parts so described and illustrated. The scope of the invention is to be defined by the claims appended hereto and their equivalents.

1. A reflective optical encoder comprising:
a gear train with a plurality of gears, wherein each of the gears is operably coupled to at least one other gear of the plurality of the gears;
a reflective code pattern accessible on a surface of at least one of the gears;
a second reflective code pattern accessible on a second surface of the same gear within the gear train;
a reflective optical sensor to detect light reflected by the reflective code pattern; and
position logic coupled to the optical sensor, the position logic to determine a rotational parameter of the gear train based on the light reflected by the reflective code pattern.

2. The reflective optical encoder of claim 1, further comprising a pinion coupled to the gear train, wherein the position logic is further configured to determine a rotational parameter of the pinion based on the rotational parameter of the gear train.

3. The reflective optical encoder of claim 2, further comprising:
a first substrate operably coupled to the gear train, wherein the reflective optical sensor is coupled to the first substrate; and
a second substrate operably coupled to the gear train opposite the first substrate.

4. The reflective optical encoder of claim 1, wherein the code pattern is applied to the surface of the at least one of the gears of the gear train.

5. The reflective optical encoder of claim 1, wherein the code pattern is integrally formed as a part of the surface of the at least one of the gears of the gear train.

6. The reflective optical encoder of claim 1, wherein the code pattern comprises a reflective plastic film, a metal code disk, or a reflective coating applied to a plastic surface.

7. The reflective optical encoder of claim 1, wherein the reflective optical sensor comprises a chip-on-board device.

8. The reflective optical encoder of claim 1, wherein the reflective code pattern is accessible on a near surface of a layer of gears, within the gear train, that is closest to the reflective optical sensor.

9. The reflective optical encoder of claim 1, wherein the reflective code pattern is accessible on a near surface of a layer of gears, within the gear train, other than a layer of gears that is closest to the reflective optical sensor.

10. The reflective optical encoder of claim 1, further comprising:
a second reflective optical sensor to detect light reflected by the second reflective code pattern.

11. (canceled)

12. (canceled)

13. The reflective optical encoder of claim 1, wherein the reflective optical encoder comprises a multi-turn encoder.

14. A reflective optical encoder comprising:
a gear;
a reflective code pattern accessible on a surface of the gear;
a reflective optical sensor to detect light reflected by the reflective code pattern;
a second reflective code pattern accessible on a second surface of the same gear within the gear train; and
position logic coupled to the reflective optical sensor, the position logic to determine a rotational parameter of the gear train based on the light reflected by the reflective code pattern.

15. The reflective optical encoder of claim 13, wherein the code pattern comprises a reflective plastic film applied to the surface of the gear.

16. The reflective optical encoder of claim 13, wherein the code pattern comprises a metal code disk coupled to the surface of the gear.

17. The reflective optical encoder of claim 13, wherein the code pattern comprises a reflective coating applied to the surface of the gear.

18. The reflective optical encoder of claim 13, further comprising:
a second reflective optical sensor to detect light reflected by the second reflective code pattern.

19. An apparatus comprising:
means for generating light incident on a surface of a gear within a gear train;
means for generating light incident on a second surface of the same gear within the gear train;
means for detecting a rotational movement of the gear within the gear train; and
means for computing a rotational movement of a pinion coupled to the gear train based on the rotational movement of the gear within the gear train.

20. The apparatus of claim 19, further comprising means for reflecting a modulated light signal from the surface of the gear within the gear train.

21. The reflective optical encoder of claim 10, further comprising a third reflective code pattern accessible on a surface of a different gear within the gear train.
